(19) United States
(12) Patent Application Publication
(10) Pub. No.: US 2025/0388464 A1
(43) Pub. Date: Dec. 25, 2025

(54) Methods and Systems for Syngas Production

(71) Applicant: Alliance for Sustainable Energy, LLC, Golden, CO (US)

(72) Inventor: Alon LIDOR, Highlands Ranch, CO (US)

(21) Appl. No.: 19/245,820

(22) Filed: Jun. 23, 2025

Related U.S. Application Data
(60) Provisional application No. 63/662,497, filed on Jun. 21, 2024.

(51) Int. Cl. C01B 3/06; B01J 8/04; C01B 3/34; C01B 13/02; C01B 32/40

(52) U.S. Cl. CPC C01B 3/063; B01J 8/0492; B01J 8/0496; C01B 3/344; C01B 13/02; C01B 32/40; B01J 2208/00115; C01B 2203/0255; C01B 2203/1241

(57) ABSTRACT

The reverse water-gas shift (RWGS) reaction, which is used to convert H2 and CO2 into syngas (H2+CO) is performed using nonstoichiometric metal oxides. The RWGS reaction is performed in two separate steps, achieving both high conversion and high energy efficiency. The reaction may be performed in a single reactor or in multiple reactors arranged in series or parallel. This could be powered either by heat generated by distributed energy sources, concentrated solar thermal (CST) heat, heat from traditional energy generation sources, and/or waste electrical power.

### CROSS-REFERENCE TO RELATED APPLICATIONS

This application claims priority to U.S. Provisional Patent Application No. 63/662,497 filed on Jun. 21, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Many of the power-to-fuels (e.g., “power-to-X” and “e-fuels”) processes that are being developed today require the reverse water-gas shift (RWGS) reaction, which has limiting thermodynamics. Being an equimolar reaction, high temperatures and a large excess of H₂ are needed to achieve reasonable CO₂ conversion at equilibrium. This has a very detrimental effect on the practical implementation of the process and the quality of the syngas that can be produced. High temperature operation increases the energy demand and reactor design complexity. On the other hand, supplying hydrogen in excess of its stoichiometric ratio (e.g., about 3H₂:1CO₂) results in a syngas composition that is not optimal for most gas-to-liquid technologies. Thus, the RWGS reaction is a major bottleneck for the deployment of e-fuel technologies and there remains a need for improved low operating temperature systems and methods that can address the thermodynamic limitations of the RWGS reaction to produce H₂ and CO₂ continuously at the ratios desired for downstream reactions that convert syngas to fuels.

### SUMMARY

An aspect of the present disclosure is a method a first reducing of a solid using a first feedstock and resulting in a first oxidizing of the first feedstock to a first product, and a second oxidizing of the solid using a second feedstock and resulting in a second reducing of the second feedstock to a second product, in which the first reducing and the second oxidizing are performed in a reactor. In some embodiments, the method also includes repeating the first reducing and the second reducing; in which the repeating is performed in the reactor. In some embodiments, the method also includes a first purging of the reactor, and a second purging of the reactor; in which the first purging is performed after the first reducing, and the second purging is performed after the second oxidizing. In some embodiments, the purging includes directing an inert gas into and out of the reactor. In some embodiments, the method also includes a first routing of the first feedstock through a first packed bed, a second routing of the first product through a second packed bed, a third routing of the second feedstock through the second packed bed, and a fourth routing of the second product through the first packed bed, in which the first routing is performed prior to the first reducing, the second routing is performed after the first reducing, the third routing is performed prior to the second oxidizing, and the fourth routing is performed after the second oxidizing. in some embodiments, the first packed bed and the second packed bed include at least one of gravel, ceramic beads, or a heat transfer fluid. in some embodiments, the method also includes receiving a heat from a heat source, in which the receiving is performed during the first reducing. in some embodiments, the heat source includes a distributed energy resource. in some embodiments, the first feedstock includes H₂, the first product includes H₂O, the second feedstock includes CO₂, and the second product includes CO. in some embodiments, the method also includes mixing the first feedstock and the second product to form a syngas. In some embodiments, the second oxidizing is performed at a temperature in the range of about 500° C. to about 900° C. In some embodiments, the CO₂ is in the second feedstock in the range of about 0 mol to about 4 mol. in some embodiments, the first feedstock includes N₂, and the first product includes N₂ and O₂. In some embodiments, the second feedstock includes water, and the second product includes H₂. In some embodiments, the first feedstock includes methane, the first product includes CO₂ and H₂O, the second feedstock includes CO₂ and H₂O, and the second product includes at least one of CO or H₂. In some embodiments, the solid includes an inorganic perovskite having a stoichiometry of ABO₃, where A is a first cation and B is a second cation. In some embodiments, A includes at least one of yttrium, lanthanum, calcium, strontium, barium, or cerium. In some embodiments, B includes at least one of titanium, chromium, manganese, iron, cobalt, or aluminum. In some embodiments, the solid includes at least one of a ceria solution or ferrite oxide. In some embodiments, the solid includes CeZr.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates an exemplary system utilizing regenerative counter-current chemical looping of the reverse water-gas shift (RWGS) reaction for the production of syngas, according to some aspects of the present disclosure.

FIG. 2A illustrates an exemplary system utilizing regenerative counter-current chemical looping of the RWGS reaction using methane as a feedstock where the methane is fully oxidized when the solid is reduced, according to some aspects of the present disclosure. FIG. 2B an exemplary system utilizing regenerative counter-current chemical looping of the RWGS reaction using methane as a feedstock where the methane is only partially oxidized when the solid is reduced, according to some aspects of the present disclosure.

FIG. 3 illustrates an exemplary system utilizing regenerative counter-current chemical looping of the RWGS reaction using methane as a feedstock and heat from a nuclear energy source, according to some aspects of the present disclosure.

FIG. 4 illustrates an exemplary system utilizing regenerative counter-current chemical looping of the reverse water-gas shift (RWGS) reaction for the production of syngas using thermal reduction of the solid with an inert gas as a feedstock, according to some aspects of the present disclosure.

FIG. 5 illustrates a chemical reactor for illustrates an exemplary system utilizing regenerative counter-current chemical looping of the reverse water-gas shift (RWGS) reaction for the production of syngas without heat recovery (panel A) and with heat recovery (panel B), according to some aspects of the present disclosure.

FIG. 6 illustrates a chemical reactor for an exemplary system utilizing regenerative counter-current chemical looping of the RWGS reaction using methane as a feedstock without heat recovery (panel A) and with heat recovery (panel B), according to some aspects of the present disclosure.

FIG. 7 illustrates a chemical reactor for an exemplary system utilizing regenerative counter-current chemical looping of the RWGS reaction using an inert gas as a feedstock without heat recovery (panel A) and with heat recovery (panel B), according to some aspects of the present disclosure.

FIG. 8 illustrates systems for converting H₂O to H₂ (Panel A), converting CO₂ to CO (Panel B), and for reducing a solid oxygen carrier to produce O₂ (Panel C), according to some embodiments of the present disclosure.

FIGS. 9A-2B illustrates systems for producing H₂ and CO utilizing features illustrated in FIG. 8, according to some embodiments of the present disclosure. FIG. 9C illustrates systems for producing H₂ and CO utilizing features illustrated in FIG. 13, according to some embodiments of the present disclosure.

FIGS. 10A-B illustrate systems for integrating the features illustrated in FIGS. 8 and 9A-C with renewable energy sources, according to some embodiments of the present disclosure.

FIG. 11 illustrates experimental thermogravimetric analysis (TGA) results of initial material screening to identify promising oxygen-storing solids, according to some embodiments of the present disclosure.

FIG. 12 illustrates the thermodynamic limits of co-feeding RWGS compared to a countercurrent oxygen permeable membrane process, according to some embodiments of the present disclosure. Panel a of FIG. 12 illustrates a conventional co-feed packed-bed catalytic reactor. Panel b of FIG. 12 illustrates oxygen chemical potential plotted vs. reaction extent to illustrate the spontaneous transfer of oxygen from higher to lower chemical potential until equilibrium is reached. Panel c of FIG. 12 illustrates equilibrium CO₂ conversion for the co-feed reactor vs. temperature and excess hydrogen. Panel d of FIG. 12 illustrates a countercurrent membrane reactor. Panel e of FIG. 12 illustrates oxygen chemical potential as a function of reaction extent in the countercurrent configuration, showing the potential for complete conversion. Panel f of FIG. 12 illustrates equilibrium CO₂ conversion for the countercurrent reactor vs. temperature and excess hydrogen.

FIG. 13 illustrates a schematic of a process, according to some embodiments of the present disclosure. Various concentration solar thermal (CST) configurations are possible to provide the process heat for the RWGS, as well as recovering the exothermic heat from the RWGS reactor during oxidation for better heat utilization.

FIG. 14 illustrates another schematic of an overall plant design for CST-driven RWGS with electrolysis and gas-to-liquid (GTL) process, according to some embodiments of the present disclosure. The system is designed to be compatible with SETO-targets for particle-based CST with TES at about 700° C.

FIG. 15 illustrates a reactor designed to reduce at least one of CO₂ and/or H₂O to CO and H₂, respectively, according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

Among other things, the present disclosure relates to the reverse water-gas shift (RWGS) reaction, which is used to convert hydrogen gas (H₂) and carbon dioxide (CO2) into syngas (which is a combination of H₂ and CO).

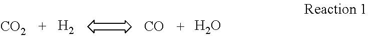

In some embodiments herein, by using nonstoichiometric metal oxides, it is possible to perform the RWGS reaction as shown in Reaction 1, in two separate steps, achieving both substantially high conversion, substantially high energy efficiency, substantially high yield of CO, and at H₂:CO ratios substantially suited for conversion to useable fuels. As shown herein, this may be achieved by, in a first step, reducing a solid oxygen carrier using H₂ as a reducing agent, forming H₂O in the process, as shown in Reaction 2, followed by splitting CO₂ to CO (Reaction 3), using a reduced solid oxygen carrier (which is oxidized). In some embodiments of the present disclosure, the first reduction reaction may be performed in a first reactor and the second reduction reaction may be performed in a second, separate, dedicated reactor. After an initial performance of Reactions 2 and 3, the flows may be “flipped” such that the reducing gas will flow to the oxidized reactor and the oxidizing gas will flow to the reducing reactor. In some embodiments of the present disclosure, a single reactor may be utilized to perform both reduction reactions, either simultaneously (i.e., at the same time) and/or in series. In such embodiments, the reactor may be purged with an inert gas in between reactions. Both Reaction 2 and Reaction 3 are substantially reversible reactions but are driven forward (i.e., to the left) by providing “excess” amounts of water (H₂O) and CO₂. and by the constant removal of H₂ and CO produced.

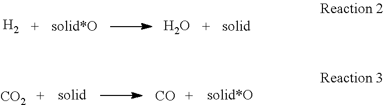

The source of the H₂ in Reaction 2 may also be used to provide the necessary H₂ for the syngas blending, thus allowing control of the resulting syngas blend composition.

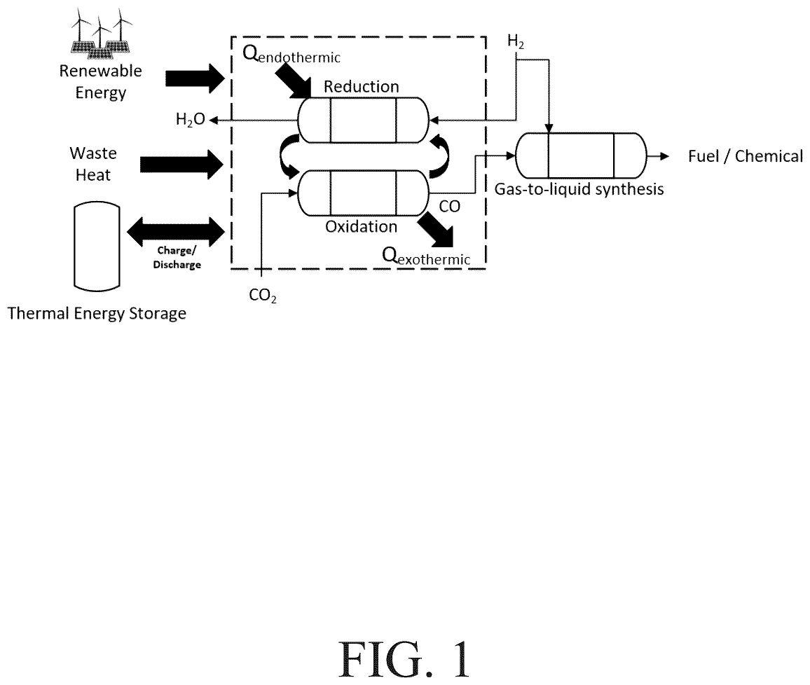

FIG. 1 illustrates an exemplary system utilizing regenerative counter-current chemical looping of the reverse water-gas shift (RWGS) reaction for the production of syngas, according to some aspects of the present disclosure. In the example shown in FIG. 1, Reaction 2 and Reaction 3 may be performed in a single reactor consecutively or may be performed in separate reactors arranged in series or parallel. Following Reaction 2 and Reaction 3, the CO (the product of Reaction 3) and H₂ (the feedstock for Reaction 2) may be mixed (i.e., combined) to form syngas.

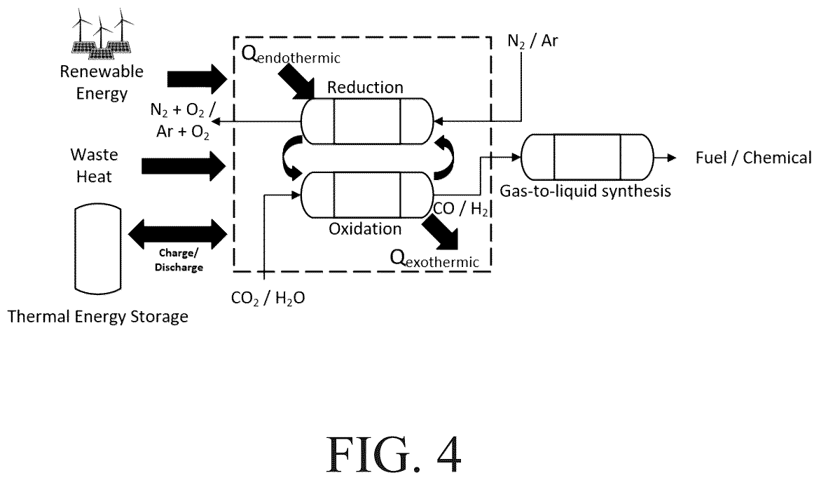

In some embodiments, as an alternative to using H₂ as a reducing agent, thermal reduction of the solid oxygen carrier may be performed using an inert gas to lower the oxygen (O₂) partial pressure while increasing the reduction temperature. In some embodiments, vacuum reduction may also be used to lower the O₂ pressure. The thermal reduction is shown in Reaction 4, using in this exemplary case nitrogen (N₂) as an inert gas. An exemplary system utilizing an inert gas (such as N₂ or Ar) is shown in FIG. 4.

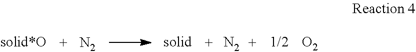

In some embodiments, when following the thermal reduction pathway, the solid oxygen carrier can also be used to produce the H₂ needed for the syngas, as shown in Reaction 5, circumventing the need for an H₂ source.

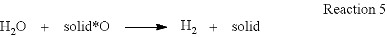

In some embodiments of the present disclosure, water and/or CO₂ may be provided from the local atmosphere, a waste stream or a flue gas (e.g., from a combustion process, manufacturing plant, etc.), and/or any other anthropogenic source of CO₂ and/or H₂O.

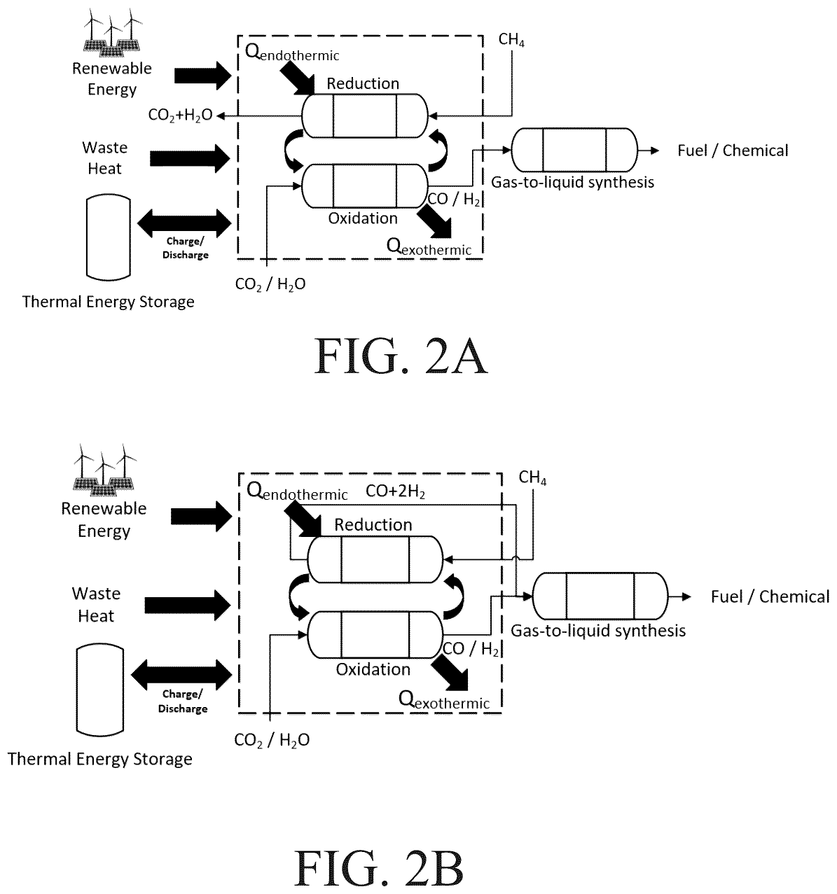

FIGS. 2A-B illustrates a chemical looping reforming of methane using countercurrent conversion using renewable energy sources, according to some aspects of the present disclosure. FIG. 2A shows where the methane is fully oxidized and FIG. 2B shows where the methane is only partially oxidized. The process shown in FIGS. 2A-B utilizes the chemical generator effect (i.e., achieving countercurrent conversion in a packed bed by using nonstoichiometric oxides and performing the reduction and oxidation steps from different flow directions). As with other embodiments described herein, the processes shown in FIGS. 2A-B utilize the RWGS and thermal reduction followed by H₂O/CO₂ splitting. The reduction reaction (assuming the methane is fully oxidized) is:

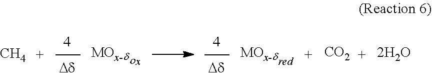

The two possible oxidation reactions are:

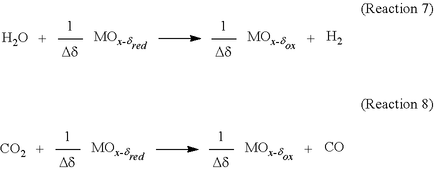

In some embodiments, the stoichiometric coefficients of the metal oxide in the oxidation reactions, it is

$$\frac{1}{Δ δ} compared to \frac{1}{Δ δ}$$

in the reduction reaction, meaning Reactions 7 and 8 must be multiplied by approximately 4 to have approximately the same amount of metal oxide used. This may result in up to approximately 4 moles of H₂/CO per one mole of CH₄. The syngas composition may still be tailored (i.e., controlled) by deciding the ratio of H₂O/CO₂. In some embodiments, the CO₂ is in the second feedstock in the range of about 0 mol to about 4 mol.

In some embodiments, the methane is only partially oxidized in the oxide reduction step, resulting in:

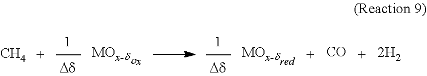

Then the cycle may be substantially closed with oxidation per Reaction 7 and/or Reaction 8. In some embodiments, the full oxidation of methane may allow for inherent CO₂ separation and potentially substantially pure H₂ production, while still keeping the syngas option under flexible H₂:CO ratios.

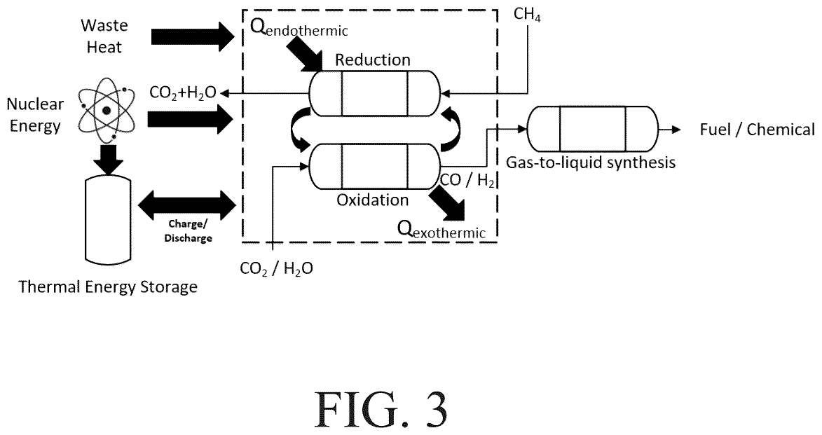

FIG. 3 illustrates an exemplary system utilizing regenerative counter-current chemical looping of the RWGS reaction using methane as a feedstock and heat from a nuclear energy source, according to some aspects of the present disclosure. The process shown in the example of FIG. 3 may be substantially the same as that shown in FIGS. 2A-B, but in this example the heat necessary for the reduction reaction may be provided by a nuclear energy source.

FIG. 4 illustrates an exemplary system utilizing regenerative counter-current chemical looping of the reverse water-gas shift (RWGS) reaction for the production of syngas using thermal reduction of the solid with an inert gas as a feedstock, according to some aspects of the present disclosure. In some embodiments, when an inert gas is used as a feedstock, vacuum reduction may also be used to lower the O₂ pressure. Because the feedstock of the oxidation reaction in this example is a combination of CO₂ and H₂O the product may be a syngas, and an additional mixing step may not be needed.

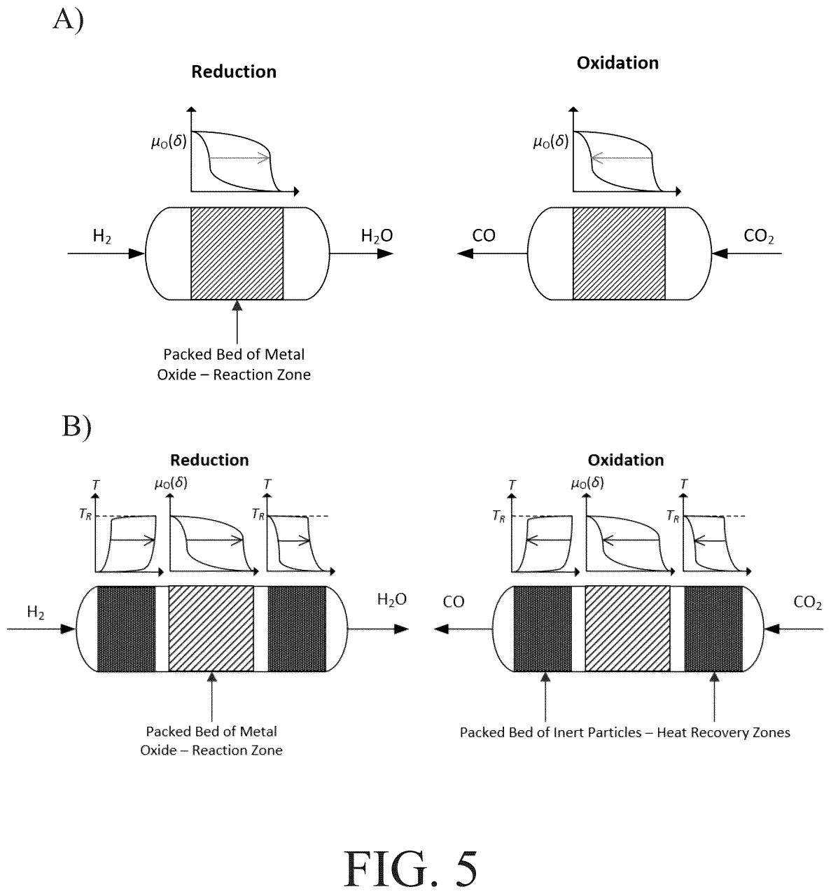

FIG. 5 illustrates a chemical reactor for illustrates an exemplary system utilizing regenerative counter-current chemical looping of the reverse water-gas shift (RWGS) reaction for the production of syngas without heat recovery (panel A) and with heat recovery (panel B), according to some aspects of the present disclosure. As shown in FIG. 5, utilizing heat recovery in a reactor where both a solid reduction and solid oxidization reaction may be performed may reduce the energy needed to perform the reactions. That is, in a single reactor, Reaction 2 may be performed, then Reaction 3 may be performed, however the flows for the feedstocks may be in opposite directions. That is, using heat recovery/thermal energy storage (for example, a packed bed of heat storage material), the heat from a H₂O product (the product of Reaction 2) may be stored to be provided to a CO₂ feedstock (the feedstock for Reaction 3). The heat recovery may be provided using a heat storage material such as gravel, ceramic beads, or a heat transfer fluid which may absorb heat from an entering flow and release it when another flow is directed through the reactor. The heat recovery may be near both the entrance and exit of the reactor, so the flow may be routed through a first heat recovery zone upon entering the reactor, undergo the reaction, then be routed through a second heat recovery zone before exiting the reactor. For the next reaction, the flow may be routed through the second heat recovery zone upon entering the reactor, undergo the reaction, then be routed through the first heat recovery zone before exiting the reactor. This process may be repeated as the two reactions are repeated by changing the direction and composition of the flows.

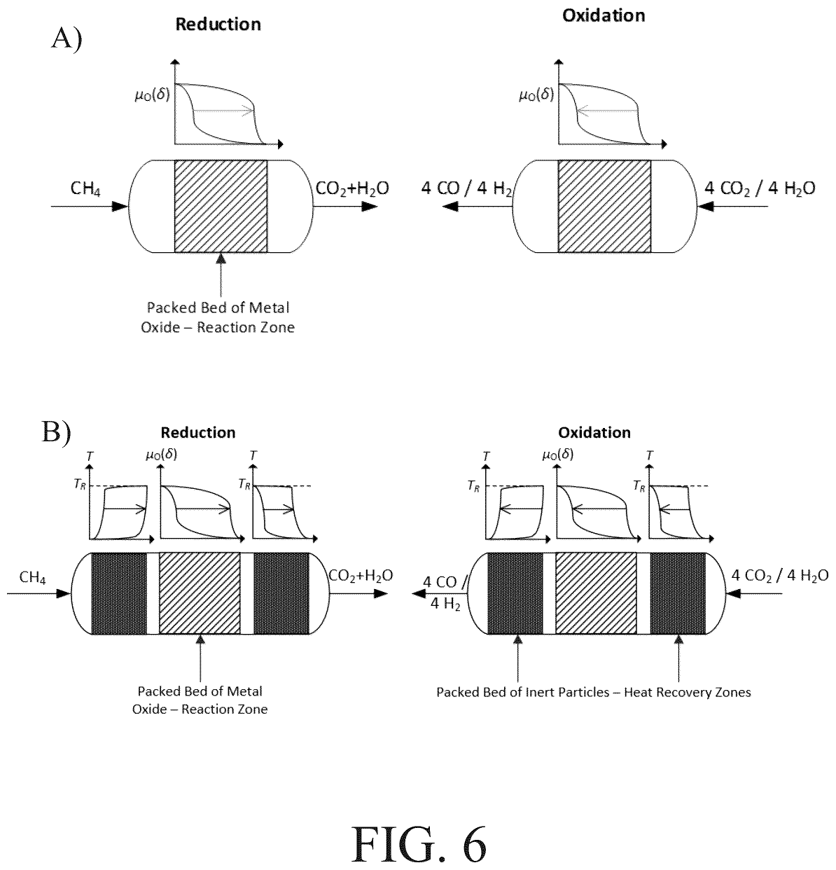

FIG. 6 illustrates a chemical reactor for an exemplary system utilizing regenerative counter-current chemical looping of the RWGS reaction using methane as a feedstock without heat recovery (panel A) and with heat recovery (panel B), according to some aspects of the present disclosure. The process shown in FIG. 6 is substantially similar to the process shown in FIG. 5, but with a change in the feedstocks and products.

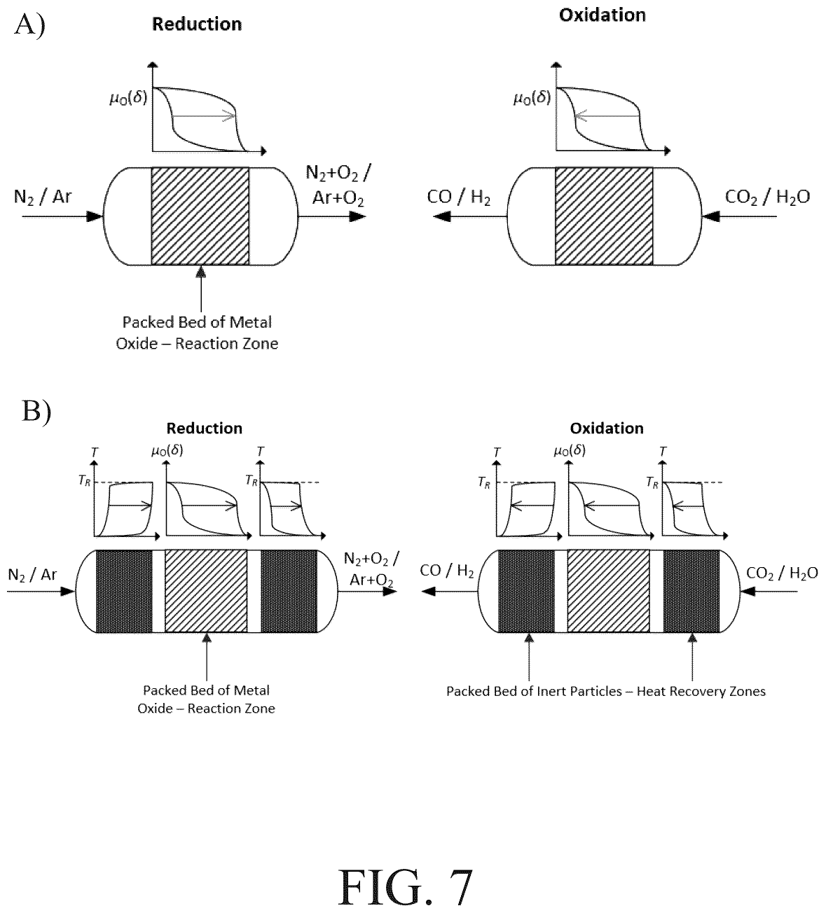

FIG. 7 illustrates a chemical reactor for an exemplary system utilizing regenerative counter-current chemical looping of the RWGS reaction using an inert gas as a feedstock without heat recovery (panel A) and with heat recovery (panel B), according to some aspects of the present disclosure. The process shown in FIG. 7 is substantially similar to the process shown in FIG. 5, but with a change in the feedstocks and products.

The heat recovery show in FIGS. 5-7 may take advantage of an embodiment where a single reactor is used for both the reduction of the solid and the oxidation of the solid, but the flows for the feedstocks are substantially opposite in direction (i.e., counter flows). For example, the first reduction reaction may occur in a first direction (shown as left to right in FIGS. 5-7) and the second oxidation reaction may occur in a second direct (shown as right to left in FIGS. 5-7). That is, the solid may remain in the reactor, but the flows through the reactor may change both in content (i.e., what is in the flow) and the direction they are flowing. The countercurrent flow set up as shown in FIGS. 5-7 may enable this use of heat recovery to make the reactions less energy intensive and improve performance.

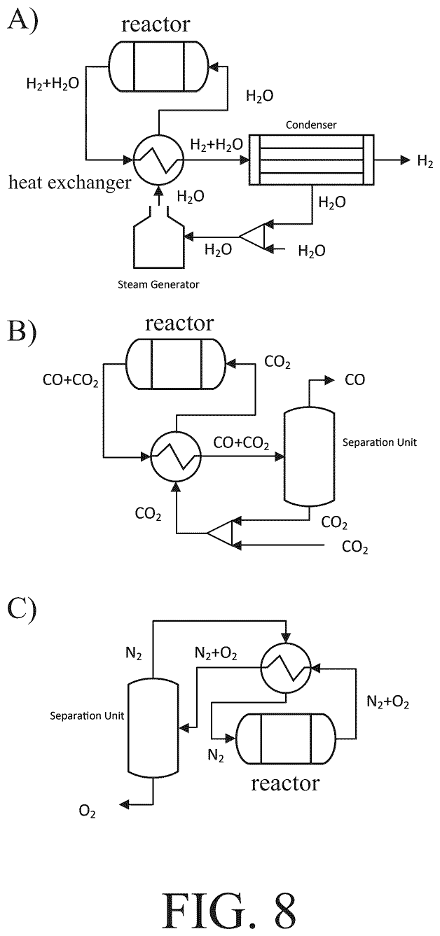

FIG. 8 illustrates systems that may be utilized to perform Reactions 2-4. Panel A of FIG. 8 illustrates a system for reducing H₂O to H₂, Panel B of FIG. 1 a system for reducing CO₂ to CO, and Panel C of FIG. 8 a system for reducing the solid from solid*O to solid.

Referring to FIG. 8, in some embodiments of the present disclosure two or more reactors may be utilized to substantially continuously produce CO and/or H₂. Two or more reactors may be positioned in parallel or in series. Among other things, separation of CO and H₂ production can help in tailoring the ratio of H₂ to CO, as well as having syngas conditioning units serve multiple racks. This is advantageous, regarding the thermal pathway, since conversion will not be complete, the syngas may need to be treated to remove unconverted reactants to ensure the H₂:CO composition fits the needs of the gas-to-liquid process. So, sized appropriately, some embodiments may include at least one conditioning unit configured to receive and treat the inlet of multiple reactors, thereby reducing the equipment costs for the overall manufacturing plant.

In some embodiments of the present disclosure, the duration of the reduction and/or oxidation steps may be based on the flow rates of the gases directed to the reactor(s). The direction of flows may be controlled by the use of multiport valves (e.g., 3-way valves), which may be positioned at either the cold side and/or the hot side of the heat exchangers used. In some embodiments of the present disclosure, there may be no need (or a reduced need) for the use of special high-temperature valves. In some embodiments of the present disclosure, a heat exchanger may be designed to operate with different feed compositions, including an inert sweep gas (e.g., N₂), CO₂ and/or H₂. In some embodiments of the present disclosure, a system may have two or more reactors with a single heat exchanger configured to treat the flows exiting and/or entering each of the two or more reactors. In some embodiments, the two reactors may “flip” their operation after the first reactions are performed (i.e., the reducing gas flows to the oxidized reactor and the oxidizing gas flows to the reducing reactor).

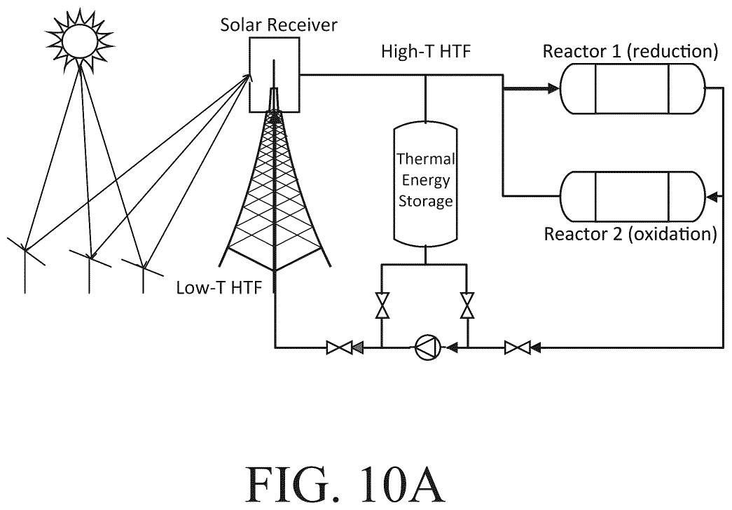

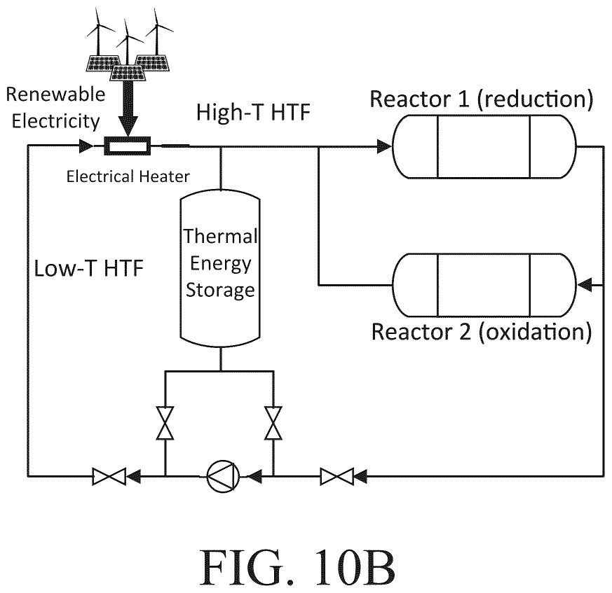

Another benefit provided by the systems and methods described herein is improved energy efficiencies, resulting from heat capture and/or integration. Referring again to FIG. 8, in some embodiments of the present disclosure, a feedstock containing at least one of H₂O and/or CO₂ may be preheated using the sensible heat of a product stream (e.g., a stream containing at least one of H₂ and/or CO). In some embodiments of the present disclosure, the exothermic heat of oxidation may be removed/captured using a heat transfer fluid (see FIGS. 10A and 10B). In some embodiments of the present disclosure, an oxidizer may enter a system at a lower temperature (T<Tₒₓ), thereby enabling the oxidizer to absorb the heat released during an oxidizing step. In some embodiments of the present disclosure, at least a portion of the exothermic heat of oxidation may be utilized to vaporize make-up water used to generate H₂. That is, in some embodiments, the heat released during the reaction may be recaptured and utilized for later reactions, improving system efficiency.

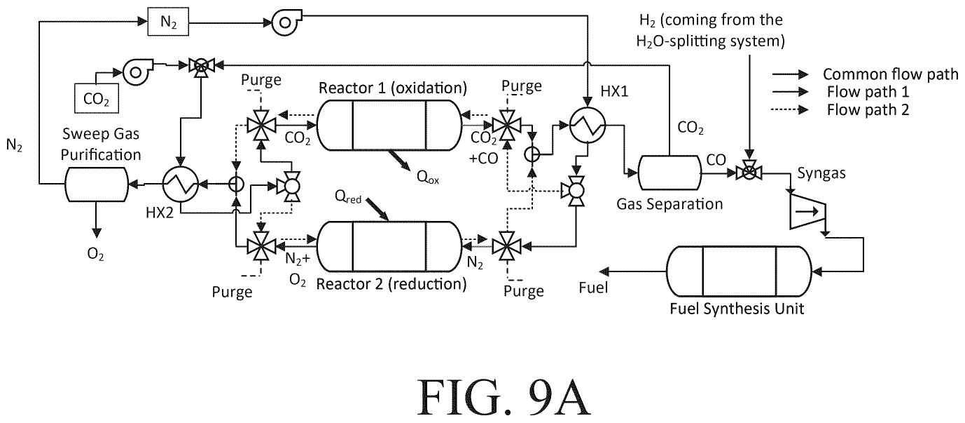

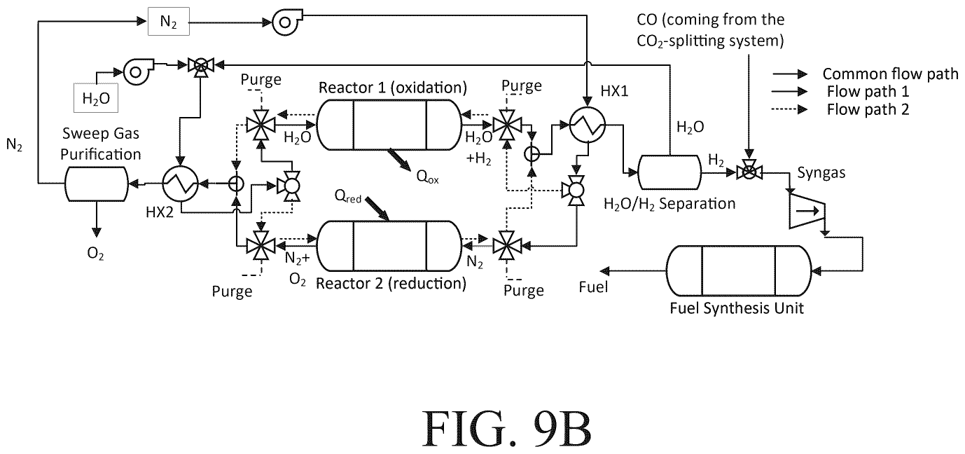

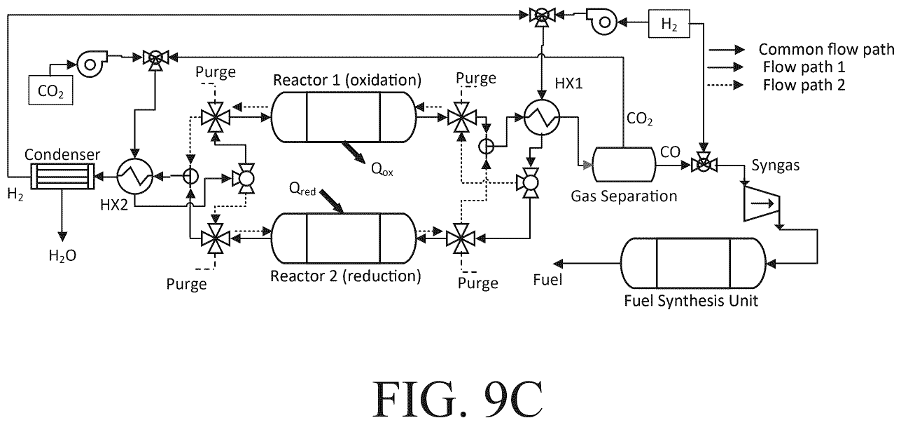

FIGS. 9A-9B illustrate systems that combine the systems illustrated in FIG. 8 simultaneously converting CO₂ and H₂O to syngas (i.e., compositions containing at least some H₂ and some CO), according to some embodiments of the present disclosure. FIG. 9C illustrates exemplary systems of the present disclosure that produce syngas using CO₂ and H₂ via the RWGS chemical looping pathway. In some embodiments, the source of H₂ could be electrolysis, steam methane reforming, or any other H₂ production method. Referring to FIGS. 9A-9C, Flow path 1 and Flow path 2 may be used interchangeably when the reactors switch (i.e., “flip”) from reduction to oxidation and vice versa. Sweep gas purification methods may include cryogenic separation, pressure swing absorption (PSA), membrane separation, and thermochemical N₂ purification. In some embodiments of the present disclosure, process heat may be supplied via a renewable energy source (see FIGS. 10A and 10B), providing the required reduction energy (Q_{red}) and in practice any heat losses from the reducing reactor. Heat recovery may be performed between the reduction reactor and oxidation reactor, or the heat of oxidation be sent back to a thermal energy storage system (TES) to be reused in later reactions (see FIGS. 10A and 10B). In some embodiments of the present disclosure, a syngas buffer tank could be added. In some embodiments of the present disclosure, purging may be achieved via the “Purge” lines illustrated in FIG. 9A. The need for CO/CO₂ gas separation may be eliminated and/or minimized if conversion is high enough, which can depend on the fuel synthesis process. In some embodiments of the present disclosure, fuel synthesis may include methanol (CH₃OH) synthesis or Fischer-Tropsch synthesis. The conversion of syngas to other fuels by other routes may also be possible. In some embodiments of the present disclosure, methods for lowering the O₂ pressure during reduction may utilize vacuum pumps instead of a sweep gas.

FIGS. 10A and 10B illustrate how the systems illustrated in FIGS. 8 and 9A-C may be integrated with renewable and/or distributed energy sources (e.g., concentrated solar, solar photovoltaics, and wind), according to some embodiments of the present disclosure. Such systems and/or methods may be useful in the emerging power-to-X field (also called “e-fuels”), in which electricity from renewable or distributed energy sources is used to produce various hydrocarbon products such as fuels and chemicals.

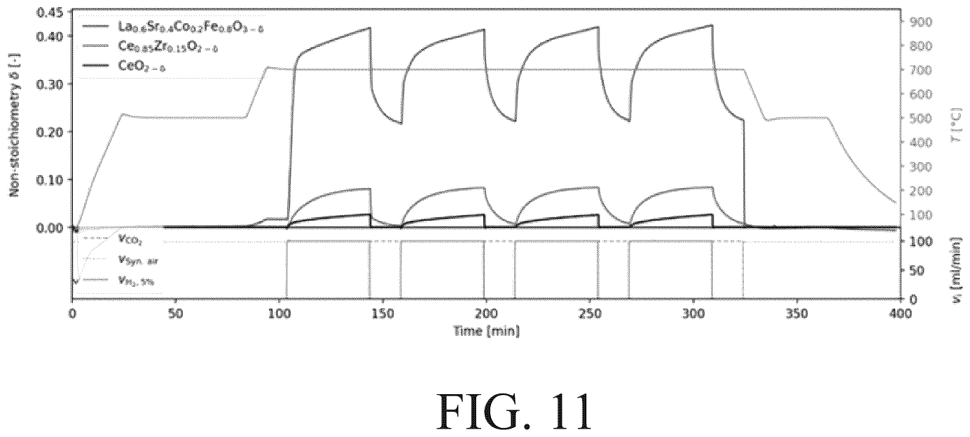

Referring again to Reaction 4, a solid used to reduce H₂O and/or CO₂ may include an inorganic perovskite, ABO₃, where A is a first cation and B is a second cation. In some embodiments of the present disclosure, A may include at least one of yttrium, lanthanum, strontium, calcium, cerium, and/or barium. In some embodiments of the present disclosure, B may include at least one of iron, cobalt, chromium, manganese, aluminum, and/or titanium. In some embodiments of the present disclosure, an inorganic perovskite may include LaₓSr₍₁₋ₓ₎Fe_{(3-y)}, wherein x is between zero and one, inclusively. In some embodiments of the present disclosure, a solid for reducing H₂O and/or CO₂ may include at least one of a ceria solution (e.g., CeZr) and/or a ferrite oxide (e.g., iron aluminates). In some embodiments of the present disclosure, a perovskite and/or some other solid may be include a mixed ionic-electronic conducting (MIEC) materials tailored to this specific application: chemically reducing when exposed to H₂ and oxidizing with CO₂ to form CO in the range of about 600° C. to about 800° C. Different MIEC materials may include the perovskite oxide family (ABO₃₋₆₇ ) and cerium oxide family (CeO₂₋₈), and cation substitutions may be employed as levers for tuning the materials for favorable chemical reduction/oxidation reactions to meet the project milestones. In some embodiments of the present disclosure, ABO₃₋₆₇ materials may include A=La and B=Al, and cation substitutions may focus on isovalent A-site cation substitutions with alkaline earth metals to improve oxygen vacancy formation and aliovalent substitutions to alter thermodynamic properties (namely increase reaction enthalpies) by changing the B-site charge. B-site substitutions may focus on identifying favorable transitional metal cations with chemical potentials to split CO₂. These substitutions will be explored within the initial materials design framework to maximize the deviation from stoichiometry (Δδ) and oxidation with CO₂→CO. We will also examine CeO_{2-δ}substitutions from transitional metal cations (e.g., Zr) with the aim of increasing reaction enthalpies and Δδ for move favorable CO₂ splitting. Initial tests showed promising results for Ce_{0.85}Zr_{0.15}O_{2-δ} and LSCF6428, exhibiting higher Δδ than CeO₂ at about 700° C. (see FIG. 11). Other promising materials are LaFeO₃/LaMnO₃ based perovskites.

Reactions 2, 3, and 5 could be performed at temperatures in the range of about 500° C. to about 900° C., depending on the exact solid oxide material used, according to some embodiments of the present disclosure. Reaction 4 may need to be at a temperature over about 1000° C., with higher temperatures better for the reduction, but limited by material (melting temperature) and process considerations. Reactions 2 and 5 may be performed at about atmospheric pressure or at higher pressures, thus negating the need for downstream compression since gas-to-liquid processes are performed at high pressures, depending on the specific process. Hence, Reactions 2 and 5 may be performed up to about 25 bars if the reactors are properly designed. Reaction 3 may be performed at about atmospheric pressure. Reaction 4 may be performed at about atmospheric pressure, but may also be performed at lower pressures, whether using vacuum pumping or in combination with inert sweep gas. Total pressures down to about 1 Pa may be used. The CO₂ and H₂O concentrations may be equilibrium concentrations at the inlet temperature, but the process can also operate with some H₂ and/or CO in the stream. The sweep gas purity in Reaction 4 may be in the range of about 99.9% to about 99.999% (about 0.1% to about 1 ppm of O₂).

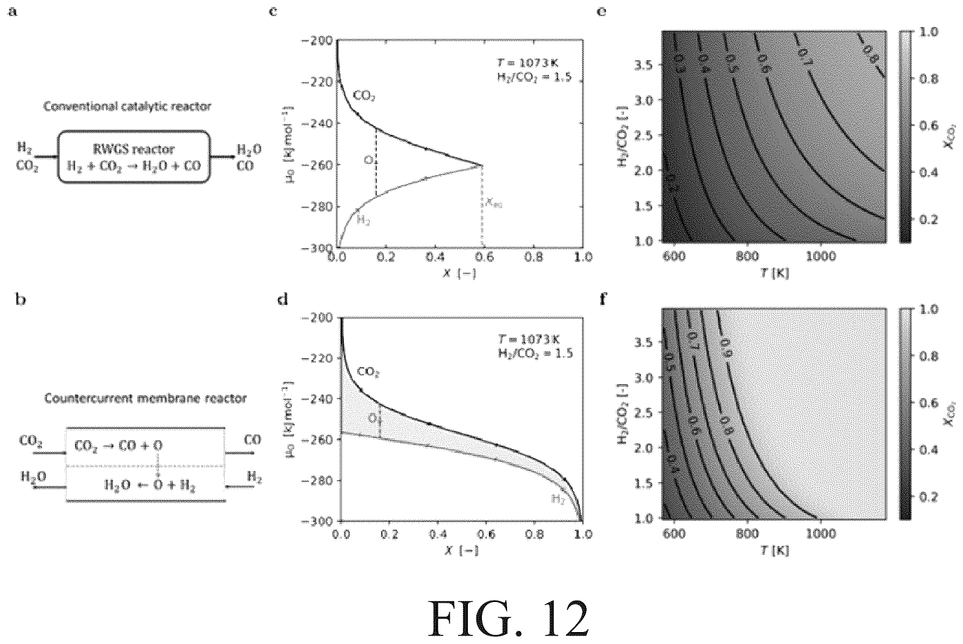

In some embodiments of the present disclosure, CO₂ conversion may be significantly improved by performing the RWGS reaction across an oxygen-permeable membrane reactor with countercurrent flow configuration. This process and the thermodynamic limits are illustrated in FIG. 12 and compared to the conventional co-feed and co-current process. However, a major limitation of such a process is the need for a large surface area in the reactor, resulting in limitations on scaling up such a system. A greater oxygen exchange capability may be achieved due to the countercurrent chemical potential inclines, similar to that of a countercurrent oxygen exchange membrane reactor. In some embodiments of the present disclosure, the RWGS may be performed in a 2-step chemical looping redox cycle with nonstoichiometric oxide.

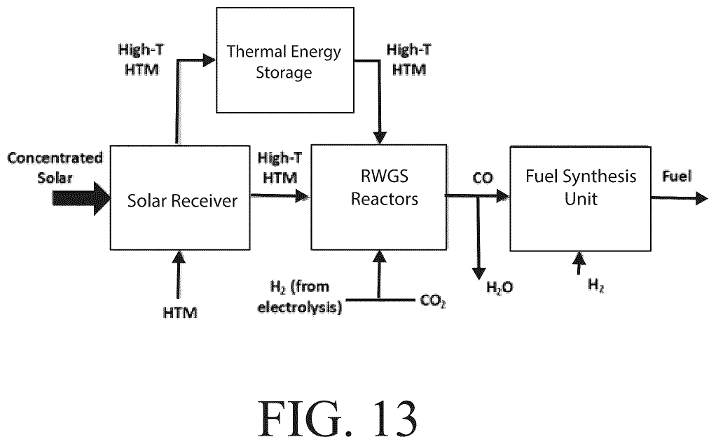

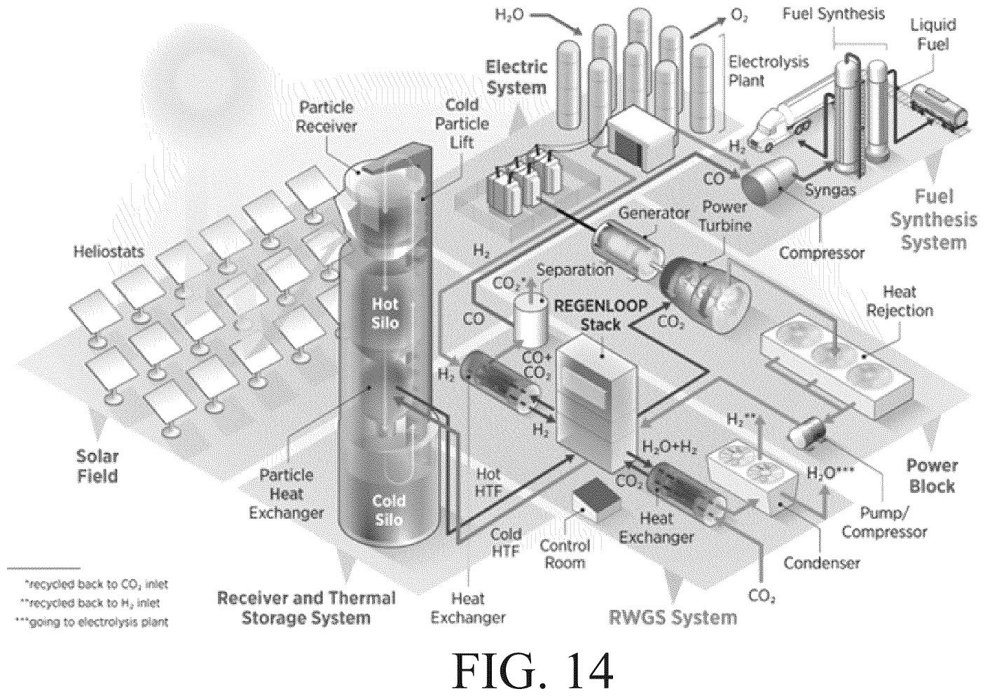

In some embodiments, the temperature range of the chemical reduction (Reaction 2) (about 700° C. to about 800° C.) is well suited for concentrated solar thermal (CST) energy. Locating such a plant in a region of good solar resource could potentially allow for CST-PV integration (PV for electrolysis, CST for RWGS), reducing costs. The temperature range is also feasible for promising thermal energy storage (TES) systems, thereby heating off-sun chemical reactors with CST combined with TES. The complete process is presented in FIG. 13, using heat transfer medium (HTM) such as particles to transfer the CST heat to the RWGS reactor (i.e., to perform heat recovery), which is well within experimentally demonstrated CST capabilities using various solar receiver designs. The cyclic nature of the process suggests two units operating in parallel, creating a continuous operation and allowing them to recover the exothermic heat released during oxidation. In addition, the high-temperature steam leaving the reactor undergoing reduction can be used in charging a TES or supporting other auxiliary processes. FIG. 14 illustrates another embodiment of a RWGS chemical looping redox reactor (REGENLOOP) that is compatible with CST technology, configured to operate at high CO₂ conversion (greater than about 90%) at about 700° C.

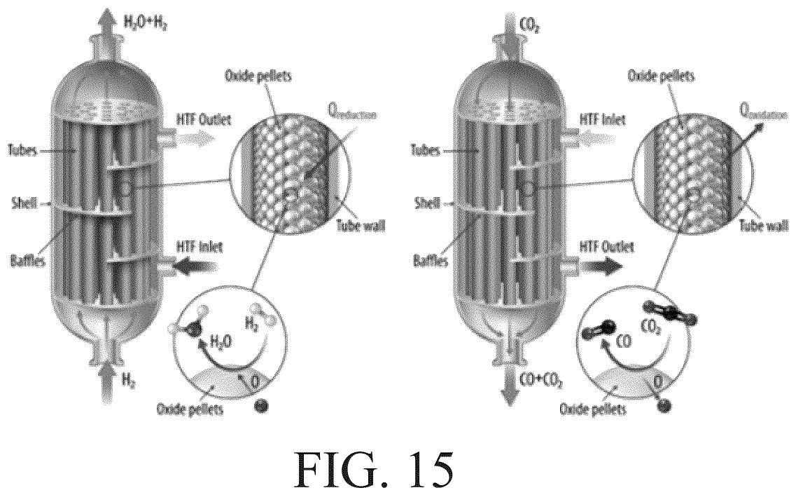

FIG. 15 illustrates an exemplary design of a reactor configured to convert CO₂ to CO via the chemical looping RWGS conversion using H₂ to reduce the solid oxide material like that described above (producing H₂O as a byproduct). In this example, the reactor has the general design of a shell-and-tube heat exchanger, where the solid is positioned within the tubes and the feed stream (i.e., a gaseous stream that includes at least one of H₂ and/or CO₂) is directed to the tubes to pass over the solid (e.g., ABO₃).

Referring again to FIG. 15, the reactor design includes both thermal- and mass-transfer aspects. The current state-of-the-art in catalytic reforming processes use an array of tubes and natural gas burners. Most of the heat is transferred to the tubes via radiation from the hot flue gases, although convective reformers have also been developed. By choosing CO₂ and/or H₂O as the heat transfer fluid (HTF), a gas emissivity over about 0.35 at a temperature in the range of about 800° C. to about 1000° C. (approximately 200° C. higher than the desired reduction temperature based on the redox material) may be obtained. Some embodiments of the present disclosure may thus generate the same heat transfer characteristics as in conventional reformers by using CST-heated HTF in lieu of burning natural gas. Two shell-and-tube heat transfer configurations may be utilized, differing by whether the HTF flow is shell-side (as shown in FIG. 15) or tube-side (inverse to FIG. 15, not shown). In addition, heat transfer enhancement techniques such as fins and flow displacement may be utilized in some embodiments. While the experimental design may include the solid material in the form of granules in a packed bed, alternative material structures may also be utilized such as reticulated porous structures and honeycombs to enhance heat and mass transfer and mitigate attrition. The final morphology of a solid may be designed and/or optimized to fit the specific process demands of a system. Further, by operating the oxidation at an elevated pressure, a process for generating syngas may also benefit from matching the pressure to the downstream gas-to-liquid (GTL) process pressure conditions. Initial heat transfer analysis for the most severe case of using pure CeO₂ with a reaction temperature of 800° C., for flow across a tube bank, yielded convective heat transfer coefficients of over about 450 W m⁻²K⁻¹, excluding the additional radiative heat transfer. HTF entering at about 1000° C. with modest Reynold's (Re) numbers (in the range of about 4500 to about 5500) have been found to sufficiently provide the required reduction enthalpy, with ΔT_{LMTG} in the range of about 140 to about 150° C. (for different H₂O—CO₂ mixtures). Oxides utilized herein may target lower reaction temperatures (in the range of about 600° C. to about 700° C.) to better fit Gen3 CSP temperatures.

Another important aspect of this design is that the same method could be used to extract the high-temperature exothermic heat during oxidation, thus preventing overheating and recovering the heat to be used in other processes or stored in a TES system. While the system cycles between reduction and oxidation, purging may be required to avoid contamination between streams. For example, a reactor with a free volume of 100 L would require about 1 mole of purge gas under the plug flow assumption when working isothermally at about 800° C. and about 1 bar (reacting about 60 moles in either reduction or oxidation). With a volumetric feed rate (v₀) of about 0.009 m³ s⁻¹ a purge of about 11 seconds is needed.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
a first reducing of a solid using a first feedstock and resulting in a first oxidizing of the first feedstock to a first product; and
a second oxidizing of the solid using a second feedstock and resulting in a second reducing of the second feedstock to a second product; wherein:
the first reducing and the second oxidizing are performed in a reactor.

2. The method of claim 1, further comprising:
repeating the first reducing and the second reducing; wherein:
the repeating is performed in the reactor.

3. The method of claim 1, further comprising:
a first purging of the reactor; and
a second purging of the reactor; wherein:
the first purging is performed after the first reducing, and
the second purging is performed after the second oxidizing.

4. The method of claim 3, wherein:
the purging comprises directing an inert gas into and out of the reactor.

5. The method of claim 1, further comprising:
a first routing of the first feedstock through a first packed bed;
a second routing of the first product through a second packed bed;
a third routing of the second feedstock through the second packed bed; and
a fourth routing of the second product through the first packed bed; wherein:
the first routing is performed prior to the first reducing,
the second routing is performed after the first reducing,
the third routing is performed prior to the second oxidizing, and
the fourth routing is performed after the second oxidizing.

6. The method of claim 5, wherein:
the first packed bed and the second packed bed comprise at least one of gravel, ceramic beads, or a heat transfer fluid.

7. The method of claim 1, further comprising:
receiving a heat from a heat source; wherein:
the receiving is performed during the first reducing.

8. The method of claim 7, wherein:
the heat source comprises a distributed energy resource.

9. The method of claim 1, wherein:
the first feedstock comprises H₂,
the first product comprises H₂O,
the second feedstock comprises CO₂, and
the second product comprises CO.

10. The method of claim 9, further comprising:
mixing the first feedstock and the second product to form a syngas.

11. The method of claim 10, wherein:
the second oxidizing is performed at a temperature in the range of about 500° C. to about 900° C.

12. The method of claim 9, wherein:
the CO₂ is in the second feedstock in the range of about 0 mol to about 4 mol.

13. The method of claim 1, wherein:
the first feedstock comprises N₂, and
the first product comprises N₂ and O₂.

14. The method of claim 1, wherein:
the second feedstock comprises water, and
the second product comprises H₂.

15. The method of claim 1, wherein:
the first feedstock comprises methane,
the first product comprises CO₂ and H₂O,
the second feedstock comprises CO₂ and H₂O, and
the second product comprises at least one of CO or H₂.

16. The method of claim 1, wherein:
the solid comprises an inorganic perovskite having a stoichiometry of ABO₃, where A is a first cation and B is a second cation.

17. The method of claim 16 wherein:
A includes at least one of yttrium, lanthanum, calcium, strontium, barium, or cerium.

18. The method of claim 16, wherein:
B includes at least one of titanium, chromium, manganese, iron, cobalt, or aluminum.

19. The method of claim 1, wherein the solid includes at least one of a ceria solution or ferrite oxide.

20. The method of claim 19, wherein:
the solid comprises CeZr.
